(19) United States
(12) Patent Application Publication
(10) Pub. No.: US 2021/0351579 A1
(43) Pub. Date: Nov. 11, 2021

(54) WIND HANG OFF

(71) Applicant: PMI Industries, Inc., Cleveland, OH (US)

(72) Inventors: Terry Zahuranec, North Olmsted, OH (US); Tyler Burger, Euclid, OH (US)

(21) Appl. No.: 17/269,586

(22) PCT Filed: Aug. 21, 2019
(86) PCT No.: PCT/US2019/047528

§ 371 Date: Feb. 19, 2021

Related U.S. Application Data
(60) Provisional application No. 62/720,542, filed on Aug. 21, 2018.
(60) Provisional application No. 62/828,868, filed on Apr. 3, 2019.

(51) Int. Cl. H02G 9/00

(52) U.S. Cl. CPC H02G 9/00

(57) ABSTRACT

A wind hang off assembly and associated method secures an associated cable to an associated structure. The assembly includes a multi-part housing that when assembled forms first and second openings having cross-sectional dimensions that receive the associated cable therethrough at opposite, first and second ends. The openings communicate with an internal cavity. A multi-part insert receives the cable therethrough, and has an outer conformation dimensioned for receipt in the housing cavity and resists movement relative to the housing. Helical rods have an axial dimension received over an associated portion of the associated cable that is received in the housing. The assembly further includes a mounting member that operatively mounts the housing to the associated structure.

This application claims the priority benefit of and expressly incorporates the entire disclosures of U.S. Serial Nos. 62/720,542, filed Aug. 21, 2018 and 62/828,868, filed Apr. 3, 2019.

### BACKGROUND

A need exists for an improved method and apparatus that secures a large diameter cable such as power and/or communication cables used, for example, in some marine applications where the cables are secured to a stationary structure such as AC based or offshore platform, wind turbine, etc.

Present-day securing assemblies pull a subsea cable through an entrance of a tube located near the base of an offshore wind turbine or platform. A “Kellems” grip is commonly used to grip and pull the cable onto the platform and allow preparatory securing steps to be completed while the cable is suspended in the tube entrance. For example, an outer cable jacketing is typically stripped away to expose and allow access to armor wires (sometimes referred to as helical rods or strengthening wires) that are located beneath the outer cable jacketing and in surrounding protective relation with the power/communication cable(s). The armor wires are cut and re-formed so that the armor wires are secured between mounting plates and or inserts, etc., to complete the securing process.

As will be appreciated, the process is complicated and requires a significant time and skill to complete. Further, known processes do not provide desired bend protection should the cable move, for example, due to the action of the ocean water. Therefore, a need exists to facilitate installation and secure mechanical engagement during installation of a hang off clamp that overcomes problems associated with known clamping arrangements that strip the outer cable jacketing and terminate the armor wire during the securing process.

### SUMMARY

A wind hang off assembly for securing an associated cable to an associated structure includes a multi-part housing that when assembled forms first and second openings having cross-sectional dimensions that receive the associated cable there through at opposite, first and second ends. The openings communicate with an internal cavity having at least a portion thereof with a larger cross-sectional dimension than the dimensions of the openings. A multi-part insert, that when assembled forms a passage dimensioned to receive the cable therethrough, has an outer conformation that is dimensioned for receipt in the housing cavity and resists movement relative to the housing. Helical rods have an axial dimension received over an associated portion of the associated cable that is received in the housing. The assembly further includes a mounting member that operatively mounts the housing to the associated structure.

In a preferred arrangement, the housing includes identical, first and second housing portions.

In one embodiment, the first and second housing portions are asymmetric along a longitudinal axis whereby the first housing portion and second housing portion mate and engage when oriented in longitudinal reverses directions relative to one another.

The first and second housing portions when assembled may encompass one-half the perimeter of the associated cable.

In a preferred embodiment the housing includes identical third and fourth housing portions.

The third and fourth housing portions may be asymmetric along a longitudinal axis whereby the third housing portion and the fourth housing portion matingly engage when oriented in longitudinal reverse direction relative to one another,

In a preferred arrangement, the first, second, third, and further housing portions are identical.

An inner surface portion preferably includes a non-slip surface to limit movement of the insert relative to the housing.

In a preferred embodiment, the mounting member includes a two-piece annular member received in one of first and second radial recesses in an outer surface of the housing to secure the assembly to the associated structure.

A nose portion may be provided at a first end of the housing, the nose portion having a tapered outer surface that increases in dimension from a terminal end thereof toward to the housing.

The helical rods may wrap a full circumference around the associated cable at either end of the housing, and/or wrap around the multi-part insert.

In a preferred arrangement, the housing includes first and second connection regions at opposite ends thereof to join a nose portion at a first end of the housing and a bending strain relief member at a second end of the housing.

The assembly may further include a joining member that engages the associated cable to exert pulling forces thereto.

A method of securing a subsea cable to an associated structure such as a platform includes positioning first and second insert portions over an external region of the subsea cable, wrapping helical rods over the insert portions and the subsea cable, locating at least first and second housing portions over the helical rods and capturing the insert portions with the housing portions, and mounting first and second plate portions on the housing portions.

The method may further include attaching a nose portion to a first end of the housing portions.

The method may also include attaching a bending strain relief to a second end of the housing portions.

The locating step may include securing identical first and second housing portions to each other by reversing a longitudinal orientation of the first housing portion relative to the second housing portion.

The locating step preferably includes securing identical third and fourth housing portions to each other, and to the first and second housing portions to complete the housing.

The method may further include coating an interior portion of the housing with a grit-like material, where the grit-like material is preferably applied by plasma spraying.

The coating step includes using grit particles sized between 100 and 400 μm, and the grit is preferably Al₂O₃.

One advantage of the present disclosure is the ability to install the assembly onto the cable on shore.

Another benefit resides in the ability to pull the cable with the assembly through a tube, for example an I-tube or a J-tube, entrance due to the small size of the assembly housing.

Since the outer jacket of the cable is left intact, installation is quicker since no armor wires are required to be bent nor is it necessary to strip the cable.

Present assembly also eliminates the need for any temporary hang off since the assembly is easily installed once the cable is pulled in place through the J-tube opening.

Adding additional external armor rods provides additional bend resistance.

Installation is simpler due to the use of split sections or portions of the housing.

Minimal training is required for installation.

The assembly is also customizable with the addition, if desired, of entrance nose cones and/or bending strain reliefs.

Yet another benefit resides in the adaptability of the same housing for use with multiple J tube sizes simply by changing the mounting plates which are the final component joined to the assembly.

Still other advantages and benefits of the present disclosure will become more apparent from reading and understanding the following detailed description.

### BRIEF DESCRIPTION OF THE DRAWINGS

FIG. 1 is a perspective view of a portion of a cable enclosed in a hang off assembly for securing the cable to an associated structure.

FIG. 2 is a perspective view similar to FIG. 1 and illustrating one conventional way of gripping and pulling the cable.

FIG. 3 is an enlarged, perspective view of a portion of the hang off assembly showing an alternative matter of gripping and pulling the cable.

FIG. 4 is an enlarged, perspective view of the individual components of the hang off assembly.

FIG. 5 is a longitudinal cross-sectional view of the individual components of the hang off assembly, and illustrating the cable in elevational view.

FIG. 6 is a perspective view of an external surface of a first housing portion.

FIG. 7 is a perspective view of an inner surface of the first housing portion of FIG. 6.

FIG. 8 is a perspective view of identical, first and second housing portions secured together.

FIG. 9 is a perspective view of a mounting plate portion particularly using gaskets for additional sealing.

FIG. 10 shows the mounting plate portion of FIG. 9 secured in place in the assembly.

FIG. 11 is a still further enlarged view of the mounting plate portion of FIGS. 9 and 10.

FIG. 12 shows an underside of the mounting plate portion and the removal material for reducing overall weight and providing access to faster components.

FIG. 13 illustrates an assembled structure.

FIG. 14 is an enlarged view of the assembly of FIG. 13.

FIG. 15 shows the cable to which the wind hang off is secured.

FIG. 16-21 illustrate individual steps in the method of assembling the components of the wind hang off to the cable.

### DETAILED DESCRIPTION

The following description with reference to the accompanying drawings is provided to assist in a comprehensive understanding of one or more embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. Various exemplary embodiments of the present disclosure are not limited to the specific details of different embodiments and should be construed as including all changes and/or equivalents or substitutes included in the ideas and technological scope of the appended claims. In describing the drawings, where possible similar reference numerals are used for similar elements.

The terms “include”, “have”, “may include”, or “may have” used in the present disclosure indicate the presence of disclosed corresponding functions, operations, elements, and the like, and do not limit additional one or more functions, operations, elements, and the like. In addition, it should be understood that the terms “include”, “including”, “have” or “having” used in the present disclosure are to indicate the presence of components, features, numbers, steps, operations, elements, parts, or a combination thereof described in the specification, and do not preclude the presence or addition of one or more other features, numbers, steps, operations, elements, parts, or a combination thereof.

The terms “or” or “at least one of A and/or B” used in the present disclosure include any and all combinations of words enumerated with them. For example, “A or B” or “at least one of A and/or B” mean including A, including B, or including both A and B.

Although the terms such as “first” and “second” used in the present disclosure may modify various elements of the different exemplary embodiments, these terms do not limit the corresponding elements. For example, these terms do not limit an order and/or importance of the corresponding elements, nor do these terms preclude additional elements (e.g., second, third, etc.). The terms may be used to distinguish one element from another element. For example, a first mechanical device and a second mechanical device all indicate mechanical devices and may indicate different types of mechanical devices or the same type of mechanical device. For example, a first element may be named a second element without departing from the scope of the various exemplary embodiments of the present disclosure, and similarly, a second element may be named a first element.

It will be understood that, when an element is mentioned as being “connected” or “coupled” to another element, the element may be directly connected or coupled to another element, or there may be an intervening element between the element and another element. To the contrary, it will be understood that, when an element is mentioned as being “directly connected” or “directly coupled” to another element, there is no intervening element between the element and another element.

The terms used in the various exemplary embodiments of the present disclosure are for the purpose of describing specific exemplary embodiments only and are not intended to limit various exemplary embodiments of the present disclosure. As used herein, the singular forms are intended to include the plural forms as well, unless the context clearly indicates otherwise.

All of the terms used herein including technical or scientific terms have the same meanings as those generally understood by an ordinary skilled person in the related art unless they are defined otherwise. The terms defined in a generally used dictionary should be interpreted as having the same meanings as the contextual meanings of the relevant technology and should not be interpreted as having inconsistent or exaggerated meanings unless they are clearly defined in the various exemplary embodiments.

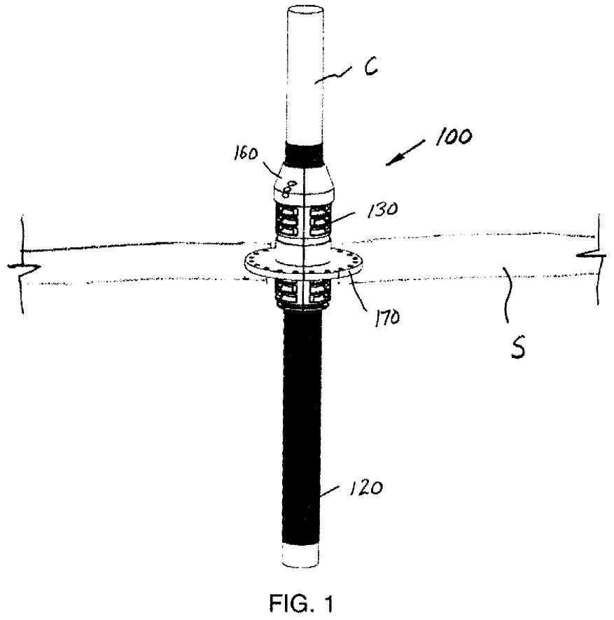

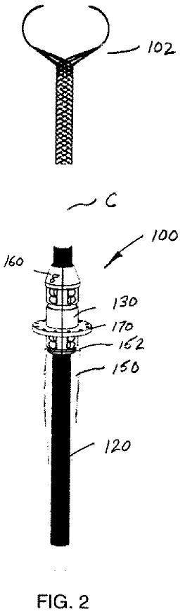

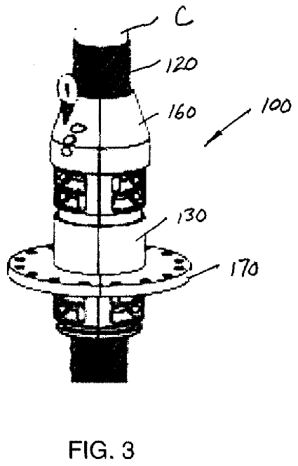

Turning initially to FIGS. 1-3, there is shown an apparatus or assembly 100 for securing large diameter cable C such as medium and high-voltage power and/or communication cable (sometimes referred herein to a subsea cable) to an associated structure S such as stationary or floating wind turbines, or other offshore platforms. The securing assembly 100 is commonly referred to as a wind hang off. When the assembly 100 is received on the cable C (typically without the split plate component), a gripping or pulling device 102 is used to pull the cable (FIG. 2) with the apparatus partially assembled thereon into position relative to the associated structure (turbine or platform). For example, the gripping or pulling device 102 may be a Kellums grip (FIG. 2), although alternative devices may be used without departing from the scope and intent of the present disclosure. One exemplary alternative structure is the provision of an eye hook or similar device accessible from an external surface of the assembly 100 (FIG. 3) to which a pulling or gripping device may be easily secured.

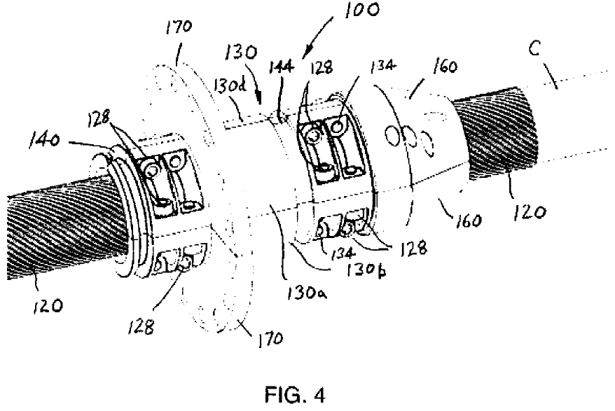

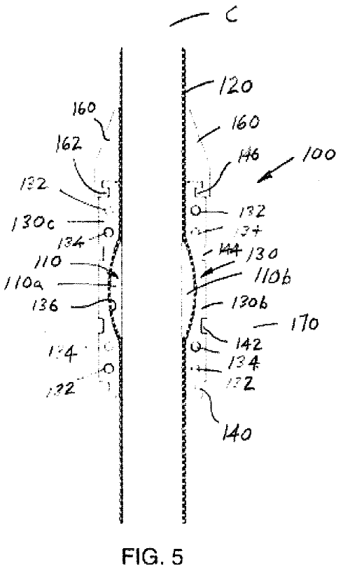

The details of the assembly 100 are more particularly illustrated in FIGS. 4 and 5. Specifically, a multi-part insert 110 is assembled about the perimeter or circumference of the cable at a desired axial location. The insert 110 may be two or more insert portions 110a, 110b, etc., that when assembled are axially or longitudinally split from one another so that the insert portions may be positioned at the same axial location around the circumference of the cable C. Again, the cable C is not stripped or opened, rather, the insert portions are received around the external surface of the cable. Preferably each insert portion is similarly shaped to reduce inventory and provide for ease of assembly. In this particular instance, each insert portion 110 has a bulbous configuration, i.e., a radially thicker portion at a central region and thinner portions at opposite ends thereof, although other configurations can be used with equal success (shaped to provide resistance to axial forces) and as will become more apparent from reading and understanding the following details of the invention.

Once the insert 110a, 10b is assembled around the cable C, helical rods or armor wires 120, are positioned in place over the external surface of the jacket of the cable C and over the insert 110. Preferably the insert 110 is generally centered within the axial longitudinal length of the helical rods 120. The helical rods 120 exert an outer gripping force on the cable C. Preferably, the entire circumference of the cable jacket is encompassed by a set of helical rods 120. Further, it is preferred that the helical rods 120 have a length that allows the rods to extend from opposite ends of the housing, and more preferably from the outer terminal ends of either a lead-in cone and bending strain relief structure that are located at opposite, axial ends of the assembly 100 and as will be described below.

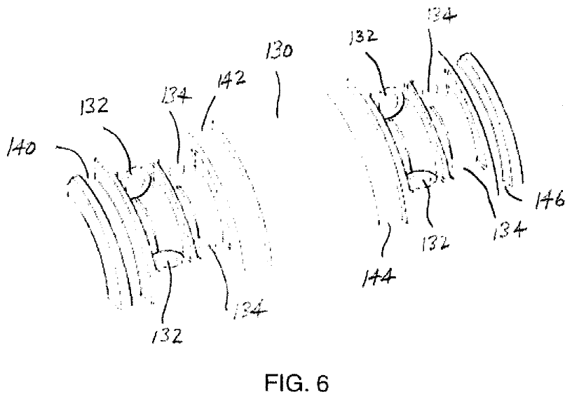

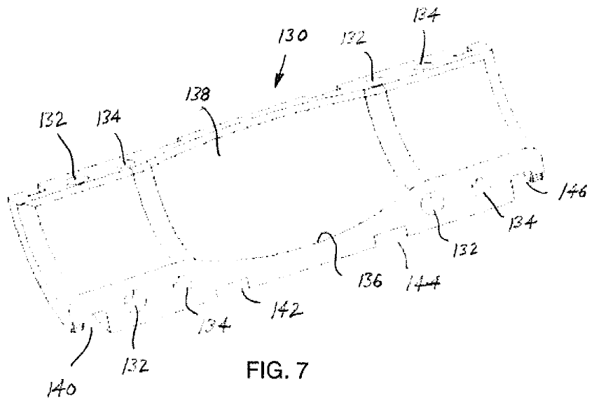

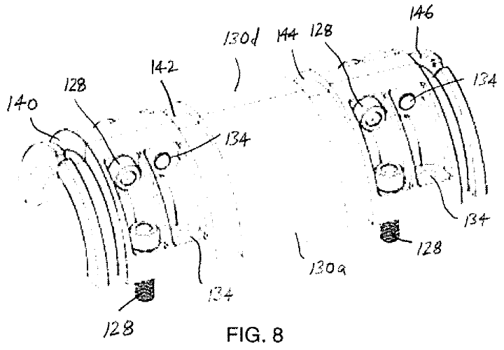

Once the insert 110, and the helical rods 120 are positioned on the cable, a multipart housing 130 is positioned over the insert and the helical rods. Preferably, the housing 130 is formed from at least two housing portions (first housing portion 130a and second housing portion 130b when each housing portion covers approximately one half the perimeter of the cable C, insert 110, and helical rods 120). In a preferred arrangement, four housing portions 130a, 130b, 130c, 130d are provided where each covers approximately one fourth of the perimeter of the cable C. Each housing portion is identical to the other housing portions. By reversing the end-to-end orientation of alternate housing portions 130, the housing portions can be fastened together to assemble a full housing about the outer perimeter of the cable, insert, and helical rods. As particularly illustrated in FIGS. 6 and 7, each housing portion forms one fourth of the housing, A fastener 128 such as threaded bolts are received through a first set of through openings 132 and a second set of internally threaded openings 134 are axially spaced from the first set of openings, but when adjacent, reverse rotated housing portions are brought into a budding engagement, the first set of openings 132 on a first housing portion aligned with the second set of internally threaded openings 134 of the second housing portion. This allows a fastener to pass through the first opening 132 in the first housing portion 130a and threadedly engage the threaded, second opening 134 of the second housing portion 130b. In this manner, for ease of manufacturing and inventory, a single housing portion is repeatedly used and by alternating the longitudinal orientation of every other housing portion around the circumference of the cable C, the complete perimeter of the cable is enclosed by the assembly 100.

As is also evident in FIG. 7, the internal configuration of the housing portion includes a bulbous configuration 136, i.e., a radially enlarged cavity portion at a central region and radially reduced portions at opposite ends thereof, although other configurations can be used with equal success (shaped to provide resistance to axial forces). When all of the housing portions are assembled, the internal cavity 136 conforms to the shape of the insert, and dimensionally receives the cable C, insert 110, and helical rods 120 therein. The bulbous shape 136 of the cavity recess relative axial movement of the cable insert 110 and helical rods 120 relative to the housing 130. Further, grit 138 may be optionally applied to the inner surface, preferably along the bulbous portion to enhance the anti-slip feature relative to the housing. The grit is preferably a particulate material that may be applied as a coating on the inside surface of the housing portions. By way of example, the grid may be applied by a plasma spray, and in one preferred arrangement is particulate Al₂O₃, where the average grid particle size ranges from approximately 100 to 400 μm.

The external surface of the assembled housing portions preferably have four recesses 140, 142, 144, 146 that are axially spaced apart and circumferentially continuous. A first recess 140 is provided for adding a flexible bending strain relief 150 (FIG. 2) structure, e.g. a radially extending portion 152 of the bending strain relief is received in the recess to enhance axial connection and resistance against pullout. Similarly, the fourth recess 146 at the opposite end of the housing portions cooperates with a cone-shaped lead-in member 160 (FIG. 5). Again, a radially extending portion 162 of the lead-in member 160 is received in the fourth recess 146 and thus enhances mechanical engagement and resistance against pullout forces.

The assembly 100 described up to this point may be completed in advance at a desired location along the axial length of the cable C. The gripping device 102 shown in connection with FIGS. 2 and 3 may then be secured to the apparatus 100 and cable C, and once the apparatus is positioned at the desired location on the stationary structure S, wind turbine, or offshore platform, a multi-part mounting plate 170 is received in one of the second and third circumferential recesses 142, 144, and secured to the J-tube.

In summary, this cable retention apparatus and method was designed for securing large cables used in a vertical, out of water application and thereby permanently attaching the cable to the entrance tube of the structure, i.e., a wind turbine, offshore platform, or similar structure. The outer gripping of the cable C with helical armor rods 120 received over the outer jacket of the cable allows the assembly to be pre-installed on shore without stripping or preparing the cable. The present assembly is then similarly pulled with a Kellems grip or other suitable gripping or pulling structure 102 and once inside the wind turbine platform, the locking plates 170 are easily and quickly attached around the housing 130 to complete the assembly 100 and provide a secure connection of the subsea cable C to the structure S. The external helical or armor rods 120 also provide additional bend protection from ocean water cable movements.

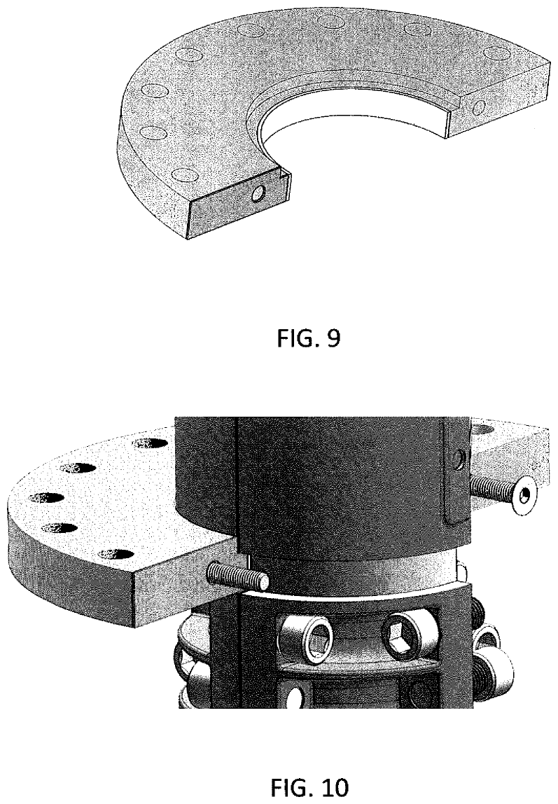

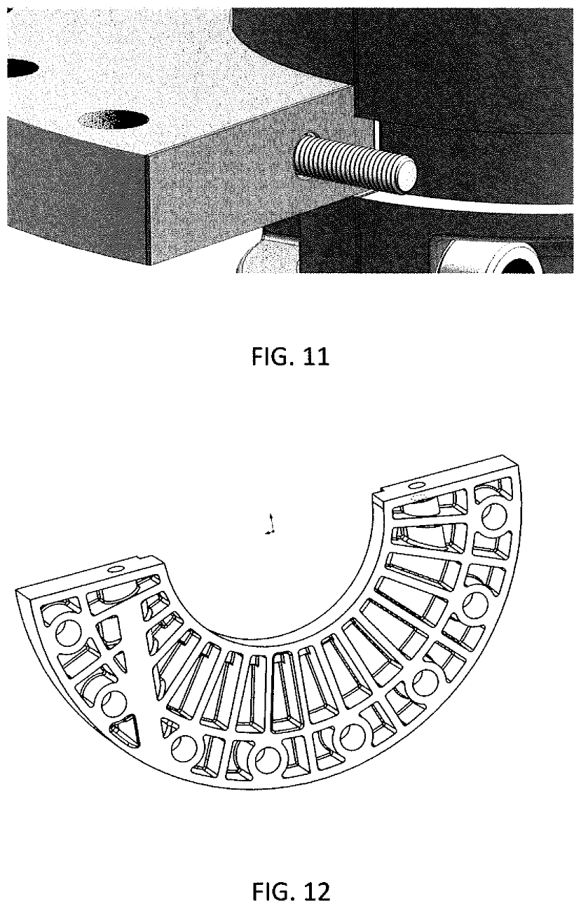

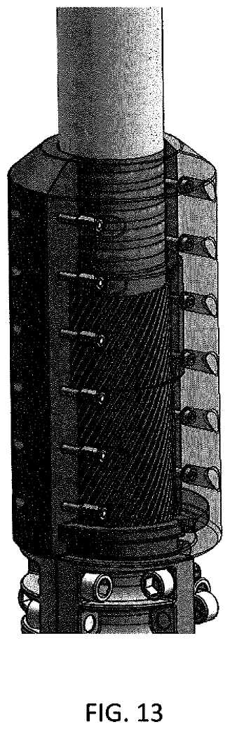

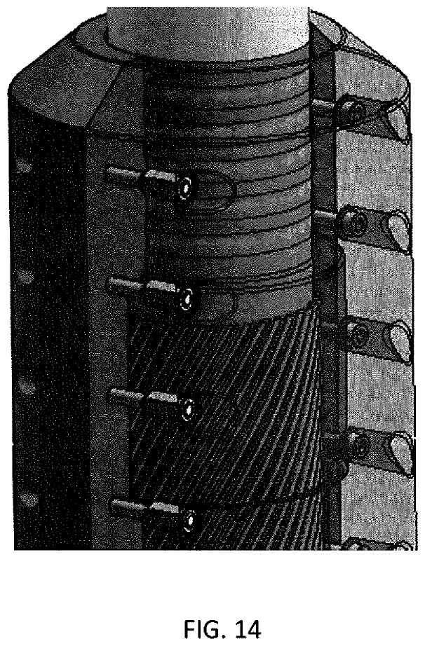

Additional modifications are illustrated in FIGS. 9-14. For example, the lead-in cone was extended to provide the ability to seal the cone to the housing and the cable jacket to prevent air/water from entering through the cable hang-off (FIGS. 13-14).

Gaskets can also be provided between the metal housing parts for additional sealing such as shown on the planar end faces of the multi-part or split mounting plate (FIGS. 9-11).

A segmented split BSR or one piece longer split BSR could be used along the bottom of the housing as an option.

The BSR and lead-in cone can be molded from a thermally conductive urethane/other material that eliminates heat being trapped by the normally insulating properties of the commonly used urethanes. The thermally conductive urethane/other material has thermal conductive improvers and modifiers such as boron nitride, alumina or other similar additives not normally found in these urethanes. Thermal conductivity is improved while advantageously maintaining electrical insulation.

An electrically conductive material could also be used as well as making the BSR segments from metal.

Additional weight can also be removed from select components such as illustrated in the mounting plate illustrated in FIG. 12. Sufficient rigidity is maintained by the structure while still allowing access to facilitate installation of fasteners.

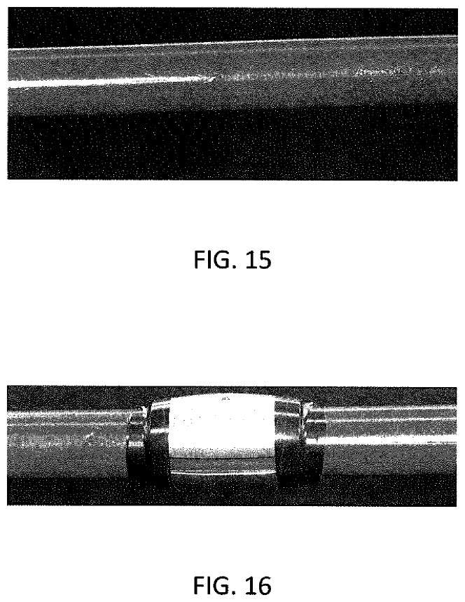

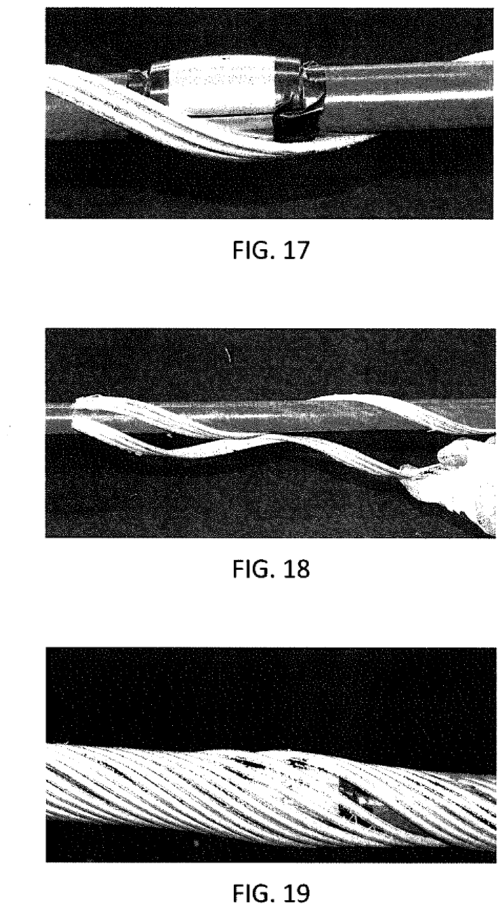

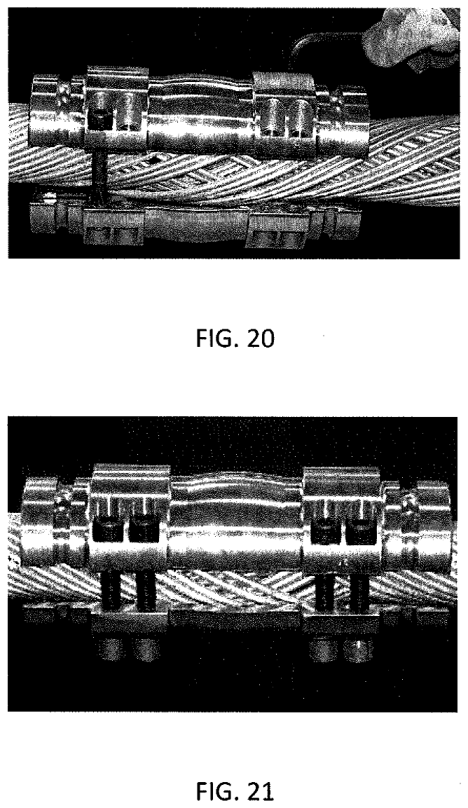

FIGS. 15-21 illustrate the preferred method of assembly of the wind hang-off. Particularly, the cable is illustrated in FIG. 15 and may be of various diameters, for example ranging in size from 50 mm through 200 mm cables, although these dimensions should not be deemed limiting. Two or more inserts are assembled about the cable and temporarily held in place by a shrink-wrap component, tape, etc. (FIG. 16). A first set of helical reinforcing rods are installed around the cable and the assembled inserts (FIG. 17). Additional helical reinforcing rods are then assembled as shown in FIGS. 18 and 19 whereby the entire circumferential extent is enclosed by the helical reinforcing rods. Thereafter, housing 130 (shown here as two housing portions or halves) is positioned about the cable and more particularly positioned so that the bulbous shape of the cavity(ies) formed in the housing/housing portions is/are aligned over the inserts already installed on the external surface of the cable. The fastener such as bolts, are then installed in tightened to complete the assembly of the housing over the helical reinforcing rods.

The resulting structure exhibits superior corrosion resistance through the judicious use of stainless steel or Duplex. The structure can be assembled to the cable prior to pulling it into a J-tube. Exterior helical reinforcing rods and additional protection against bending and also cooperate with remainder structure to provide high load capacity. Using the exterior stainless steel rods will provides the desired bend protection while the split flinch mount allows the assembly to be pulled into position and then quickly fastened. An epoxy-less sealed gasket construction also reduces installation time, as does the elimination of installing the helical reinforcing rods while at the turbine.

This written description uses examples to describe the disclosure, including the best mode, and also to enable any person skilled in the art to make and use the disclosure. Other examples that occur to those skilled in the art are intended to be within the scope of the invention if they have structural elements that do not differ from the same concept, or if they include equivalent structural elements with insubstantial differences.

1. A wind hang off assembly for securing an associated cable to an associated structure, the assembly comprising:
a multi-part housing that when assembled forms first and second openings having cross-sectional dimensions that receive the associated cable therethrough at opposite, first and second ends, the openings communicating with an internal cavity having at least a portion thereof with a larger cross-sectional dimension than the dimensions of the openings;
a multi-part insert that when assembled forms a passage dimensioned to receive the cable therethrough, the insert having an outer conformation that is dimensioned for receipt in the housing cavity and resists movement relative to the housing;
helical rods having an axial dimension received over an associated portion of the associated cable that is received in the housing; and
a mounting member that operatively mounts the housing to the associated structure.

2. The assembly of claim 1 wherein the housing includes identical, first and second housing portions.

3. The assembly of claim 2 wherein the first and second housing portions are asymmetric along a longitudinal axis whereby the first housing portion and second housing portion matingly engage when oriented in longitudinal reverses directions relative to one another.

4. The assembly of claim 2 wherein the first and second housing portions when assembled encompass one-half the perimeter of the associated cable.

5. The assembly of claim 2 wherein the housing includes identical third and fourth housing portions.

6. The assembly of claim 5 wherein the third and fourth housing portions are asymmetric along a longitudinal axis whereby the third housing portion and the fourth housing portion matingly engage when oriented in longitudinal reverse direction relative to one another.

7. The assembly of claim 2 wherein the third and fourth housing portions when assembled encompass one-half the perimeter of the associated cable.

8. The assembly of claim 5 wherein the first, second, third, and further housing portions are identical.

9. The assembly of claim 1 wherein an inner surface portion includes a non-slip surface to limit movement of the insert relative to the housing.

10. The assembly of claim 1 wherein the mounting member includes a two-piece annular member received in one of first and second radial recesses in an outer surface of the housing to secure the assembly to the associated structure.

11. The assembly of claim 1 further comprising a nose portion at a first end of the housing, the nose portion having a tapered outer surface that increases in dimension from a terminal end thereof toward to the housing.

12. The assembly of claim 1 wherein the helical rods wrap a full circumference around the associated cable at either end of the housing.

13. The assembly of claim 1 wherein the helical rods wrap around the multi-part insert.

14. The assembly of claim 1 wherein the housing includes first and second connection regions at opposite ends thereof to join a nose portion at a first end of the housing and a bending strain relief member at a second end of the housing.

15. The assembly of claim 1 further comprising a joining member that engages the associated cable to exert pulling forces thereto.

16. A method of securing a subsea cable to an associated structure such as a platform, the method comprising:
positioning first and second insert portions over an external region of the subsea cable;
wrapping helical rods over the insert portions and the subsea cable;
locating at least first and second housing portions over the helical rods and capturing the insert portions with the housing portions; and
mounting first and second plate portions on the housing portions.

17. The method of claim 16 further comprising attaching a nose portion to a first end of the housing portions.

18. The method of claim 16 further comprising attaching a bending strain relief to a second end of the housing portions.

19. The method of claim 16 wherein the locating step includes securing identical first and second housing portions to each other by reversing a longitudinal orientation of the first housing portion relative to the second housing portion.

20. The method of claim 19 wherein the locating step includes securing identical third and fourth housing portions to each other, and to the first and second housing portions to complete the housing.

21. The method of claim 16 further comprising coating an interior portion of the housing with a grit-like material.

22. The method of claim 21 wherein the grit-like material is applied by plasma spraying.

23. The method of claim 21 wherein the coating step includes using grit particles sized between 100 and 400 μm.

24. The method of claim 21 wherein the grit is Al₂O₃.
